(19) United States
(12) Patent Application Publication
(10) Pub. No.: US 2013/0118626 A1
(43) Pub. Date: May 16, 2013

(54) METHOD OF ATTACHING A STIFFENING WIRE INSIDE A FLEXIBLE HOSE ASSEMBLY

(71) Applicant: Steven E. Broerman, Cincinnati, OH (US)

(72) Inventor: Steven E. Broerman, Cincinnati, OH (US)

(73) Assignee: ILLINOIS TOOL WORKS INC., Glenview, IL (US)

(21) Appl. No.: 13/296,473

(22) Filed: Nov. 15, 2011

(51) Int. Cl. F16L 11/00

(52) U.S. Cl. 138/103; 29/428

(57) ABSTRACT

A flexible hose assembly for directing a compressed fluid towards a site is provided. The assembly includes, but is not limited to, a flexible hose, a nozzle, a stiffening wire, and a connecting member. The flexible hose forms an inner fluid channel and has an inlet at a first end which receives the compressed fluid and an outlet at a second end which delivers the compressed fluid. The nozzle is connected with an outlet of the flexible hose. The compressed fluid travels through the nozzle and is directed at the site. The stiffening wire is located in the inner fluid channel. The connecting member has an outlet channel located at the inlet and in the inner fluid channel. The outlet channel is surrounded by the flexible hose. A connecting end of the stiffening wire is fitted between the outlet channel and the flexible hose.

### FIELD OF THE INVENTION

The present invention relates generally to compressed air nozzles and, more particularly, to compressed air nozzles attached to a flexible hose.

### BACKGROUND OF THE INVENTION

Certain applications require high pressure (60 to 150 psig/4.1 to 10.3 bar) compressed air nozzles for blow-off applications. The compressed air nozzles have specialized air nozzle assemblies whereby the compressed air nozzle is attached to a flexible hose. Preferably, the flexible hose has a “memory” which allows the hose to be manually flexed into one of multiple fixed positions. The memory allows for air from the air nozzle on the end of the hose to be directed or aimed at a one of a number of predetermined locations. If air from the air nozzle is to be directed at a different location, the flexible hose can be manually bent or re-positioned into a new set position, and the flexible hose will maintain the new set position, even if the flexible hose, and the air nozzle, are operating under high internal pressures. The specialized air nozzle assemblies whereby the air nozzle is attached to a flexible hose are also referred to as “flexible hose assemblies” or “stay-set hoses,” and can be made in various lengths and air flow ranges. Generally, the length of the flexible hose assemblies range from 6 to 36 inches long and the air flows from 5 to 35 standard cubic feet per minute (scfm) (140 to 990 liters per minute).

With reference to FIGS. 1A and 1B, one method that allows a flexible hose assembly 10, having a nozzle 30 connected at one end, to maintain a set but variable position is by inserting a metal stiffening (heavy gauge copper wire is typically used) wire 50 into the inside diameter of a flexible (rubber, vinyl, polyurethane, etc.) hose 20 and fix one end of the wire 50 to one end of the hose 50 or at a threaded hose connection 60, as disclosed in U.S. Pat. No. 4,385,728.

There are various known ways to fix one end of the wire 50 to one end of the hose 20 or at a threaded hose connection 60: 1) solder or braze the wire to the hose connection; 2) crimp offset bends 40, 42 into an end of the wire 50 so that the wire 50 is held by friction inside the hose connection 60; 3) crimp offset bends 40, 42 at or near an end 52 of the wire 50 and solder or braze the crimped end 52 to the hose connection 60; or 4) form the end 52 of the wire 50 so that edges of the wire 50 contact the hose connection 60 so that they can be soldered or brazed together. All of these methods must allow space between the stiffening wire 50 and an inner channel 62 of the hose connection 60 and the hose 20 itself, so that fluid (compressed air) can flow through the hose 20 to the nozzle 30 on the opposite end of the assembly 10. So therefore typically the diameter d₁ of the stiffening wire 50 is about ⅓ to ½ the inside diameter d₂ of the hose connection 60 or the inside diameter d₃ of the hose 20. This allows for adequate space for compressed air to flow through the assembly 10.

Other methods that allows a flexible hose assembly to maintain a set but variable position is by manufacturing the hose from a material that naturally maintains its position or by manufacturing the hose in a configuration that allows it to bend repeatedly, for example, a corrugated metal hose style.

There are problems associated with the above-described methods of constructing a hose assembly described above. One problem that is prevalent with the first method described is that the solder (or brazed) connection is often not reliable, may be difficult to manufacture, and the solder (or brazed) joint may break after several flex cycles of the wire. One problem with the second method is cost. Corrugated metal hose may be costly and prohibitive for use in a simple flexible hose assembly.

As a result, it would be desirable to have an alternate way to fix an end of the stiffening wire to one end of the hose in order to reduce problems associated with the costs manufacturing the flexible hose assembly and also to reduce problems associated with reliability of the connection of the stiffening wire with one end of the hose.

### SUMMARY

The present invention is defined by the following claims, and nothing in this section should be taken as a limitation on those claims.

In one aspect, a flexible hose assembly for directing a compressed fluid towards a site is provided. The assembly includes, but is not limited to, a flexible hose, a nozzle, a stiffening wire, and a connecting member. The flexible hose forms an inner fluid channel and has an inlet at a first end which receives the compressed fluid and an outlet at a second end which delivers the compressed fluid. The nozzle is connected with an outlet of the flexible hose. The compressed fluid travels through the nozzle and is directed at the site. The stiffening wire is located in the inner fluid channel. The connecting member has an outlet channel located at the inlet and in the inner fluid channel. The outlet channel is surrounded by the flexible hose. A connecting end of the stiffening wire is fitted between the outlet channel and the flexible hose.

In one aspect, a method for attaching a stiffening wire inside a flexible hose assembly is provided. The method includes, but is not limited to, positioning a stiffening wire, located in an inner fluid channel of a flexible hose, in between a connecting member and the flexible hose. The method also includes, but is not limited to, connecting the stiffening wire with the connecting member.

In one aspect, a flexible hose assembly is provided. The flexible hose assembly includes, but is not limited to, a flexible hose, a nozzle, a connecting member, and a stiffening wire. The flexible hose forms an inner fluid channel. The nozzle is connected with an outlet of the flexible hose. The connecting member is connected with an inlet of the flexible hose and has a portion located in the inner fluid channel. The stiffening wire is located in the inner fluid channel between the connecting member and the flexible hose.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1A depicts a perspective view of a flexible hose assembly.

FIG. 1B depicts a side cross-sectional view taken along line 1-1 of the flexible hose assembly shown in FIG. 1A.

FIG. 1C depicts a cross-sectional view taken along line A-A of the flexible hose assembly shown in FIG. 1B.

FIG. 2A depicts a perspective view of a flexible hose assembly, in accordance with one preferred embodiment.

FIG. 2B depicts a side cross-sectional view taken along line 2-2 of the flexible hose assembly shown in FIG. 2A having an end of a stiffening wire received by a receiving channel, in accordance with one preferred embodiment.

FIG. 3A depicts an enlarged partial side cross-sectional view of a flexible hose assembly having an end of a stiffening wire received by a securing channel, in accordance with one preferred embodiment.

FIG. 3B depicts a cross-sectional view taken along line B-B of the flexible hose assembly shown in FIG. 3A, in accordance with one preferred embodiment.

FIG. 4A depicts a side cross-sectional view of a flexible hose assembly having connecting member which forms a receiving channel and a securing channel, in accordance with one preferred embodiment.

FIG. 4B depicts a cross-sectional view taken along line C-C of the flexible hose assembly shown in FIG. 4A, in accordance with one preferred embodiment.

FIG. 5A depicts a side view of the connecting member shown in FIG. 4A, in accordance with one preferred embodiment.

FIG. 5B depicts an end view taken of the connecting member shown in FIG. 5A, in accordance with one preferred embodiment.

FIG. 5C depicts an end cross-sectional view taken along line D-D of the connecting member shown in FIG. 5A, in accordance with one preferred embodiment.

FIG. 5D depicts an end cross-sectional view taken along line E-E of the connecting member shown in FIG. 5A, in accordance with one preferred embodiment.

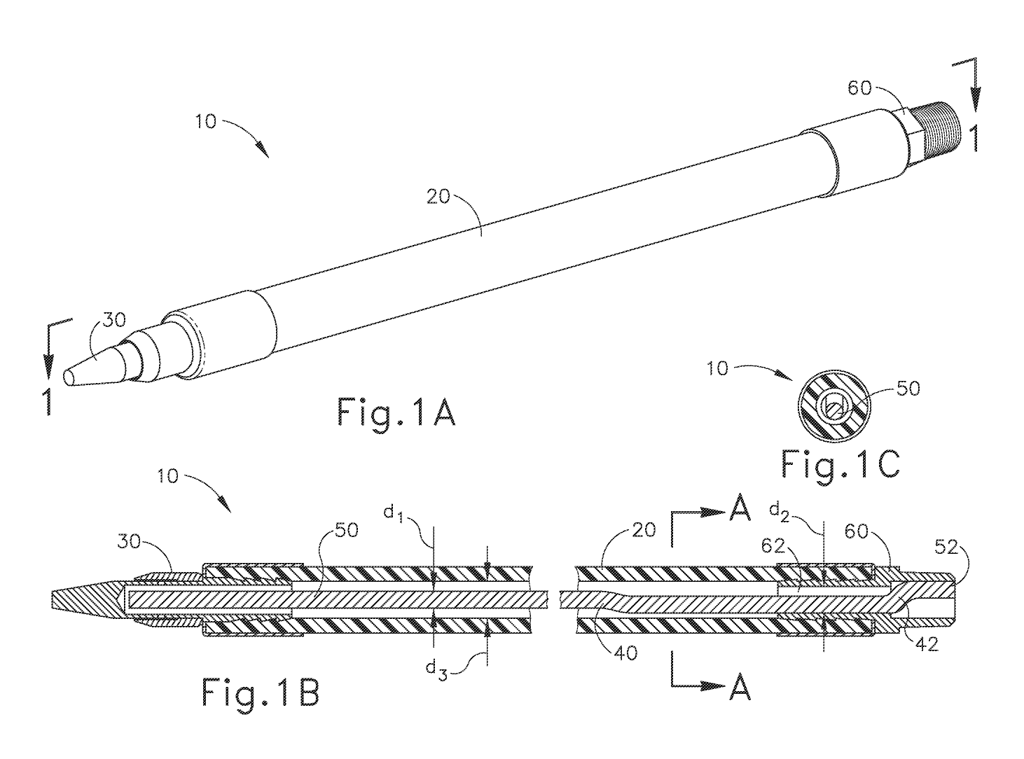

### DETAILED DESCRIPTION

Methods and devices consistent with the present invention overcome the disadvantages of conventional flexible hose assemblies by positioning a stiffening wire, located in an inner fluid channel of a flexible hose, in between a connecting member and the flexible hose. The stiffening wire is then connected to the connecting member, preferably, by compressing a connecting end ferrule surrounding a portion of the flexible hose, a connecting end of the stiffening wire, and a portion of the connecting member. This improved method for attaching a stiffening wire to a flexible hose assembly reduces problems associated with the costs manufacturing the flexible hose assembly and also reduces problems associated with reliability of the connection of the stiffening wire with one end of the hose.

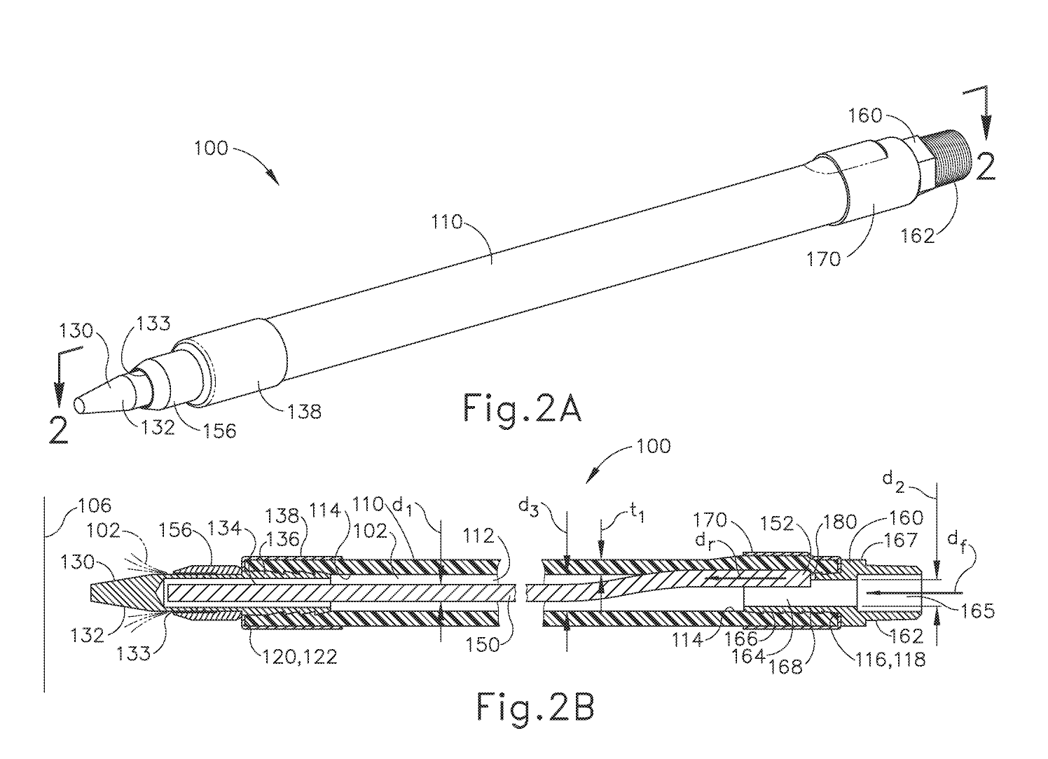

With reference to FIG. 2, a side cross-sectional view of a flexible hose assembly 100 consistent with the present invention is provided. The flexible hose assembly 100 is provided to direct a fluid 102, preferably a compressed fluid 102, towards a site 106. Fluid 102 is any material or substance that continually deforms and flows under an applied shear stress, no matter how small. Fluid 102 includes materials which are under a subset of one of the phases of matter including liquids, gas, plasmas and, to some extent, plastic solids. In one embodiment, fluid 102 is any material in gaseous form, such as air, and preferably, a compressed gas such as air which is compressed to a pressure of 100 kPa to 1200 kPa, and preferably a pressure of 137 kPa to 1034 kPa. Flexible hose assembly 100 may be used for controlled airflow applications or blow-off applications in which fluid 102 is directed towards a site 106 to blow-off and remove excess material from an object, and or cool an object. In one embodiment, flexible hose assembly 100 can deliver compressed airflows from 0.10 to 1.0 cubic meters/minute, using only compressed air as a power source.

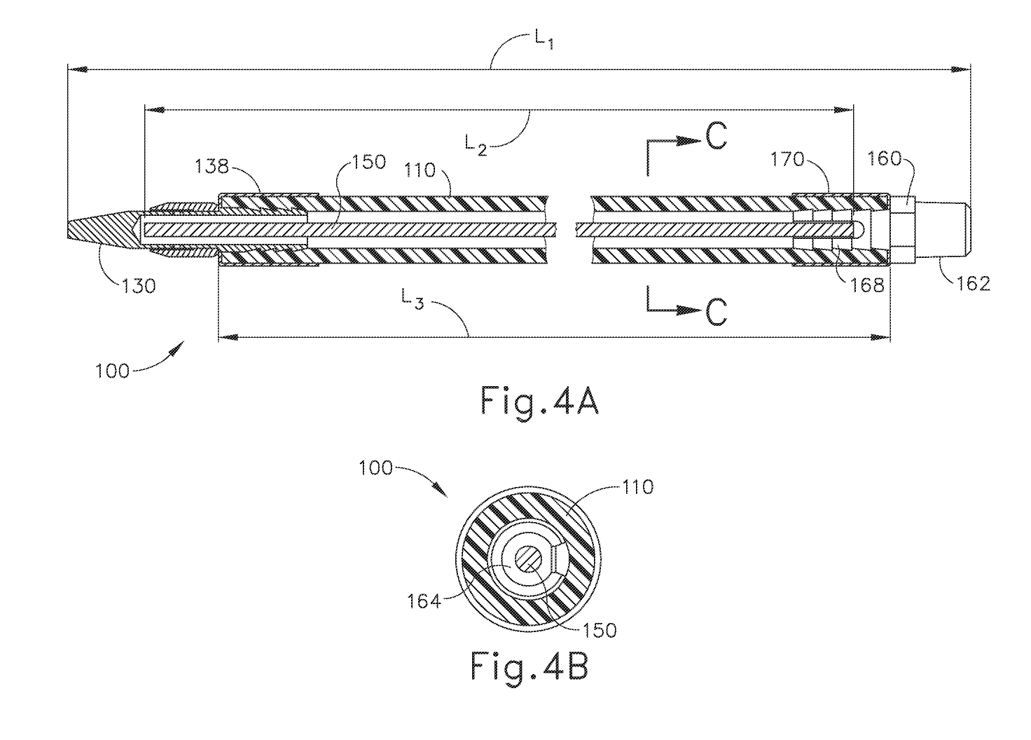

In one embodiment, flexible hose assembly 100 includes a flexible hose 110, a nozzle 130, a stiffening wire 150, and a connecting member 160. The flexible hose 110 forms an inner fluid channel 112 and has an inlet 116 at a first end 118 which receives the fluid 102 and an outlet 120 at a second end 122 which is directed towards and delivers the fluid 102 to site 106. Preferably, the flexible hose 110 is comprised of a flexible material which can also act as a barrier to prevent gas from escaping through, such as copper, metal, plastic, rubber, vinyl, or polyurethane. In one embodiment, the flexible hose 110 comprises copper tubing, plastic tubing, or a rubber hose. With reference to FIGS. 2 and 4A, in one embodiment, the flexible hose 110 has a length L₃ from 10 to 100 cm, and preferably from 15 to 91 cm, and a thickness t₁ from 0.15 to 1.0 cm.

With reference to FIG. 2, nozzle 130 is connected with outlet 120 of the flexible hose 110. Preferably, nozzle 130 includes a nozzle head 132 which extends out from the inner fluid channel 112 of the hose 110 and past the second end 122 of the hose 110 and forms an opening or outlet 133 through which fluid 102 flows and is directed towards site 106. Preferably, the nozzle head 132 forms an inner channel with a narrowing circumference through which the fluid 102 travels through and through which the fluid 102 is further compressed. Preferably, the nozzle head 132, and/or the inner channel within the nozzle head 132, is frustoconically shaped, wherein an inlet to the nozzle head 132 forms a larger opening than the outlet 133, further compressing fluid 102 as it travels through the nozzle head 132.

Preferably, nozzle 130 forms an inlet channel 134 which extends into the inner fluid channel 112 at the outlet 120 of the flexible hose 110. Preferably, the inlet channel 134 is surrounded by at least one hose barb 136, and preferably, a plurality of hose barbs 136 which project outwardly from the inlet channel 134. Hose barbs 136 project into and press against an inner surface 114 of the flexible hose 110 to help secure the nozzle 130 to the flexible hose 110 at the second end 122 and outlet 120. Inner surface 114 defines the inner fluid channel 112. Preferably, the nozzle 130 is comprised of a stiff material such as a metal including steel, brass, and aluminum; or a hard plastic. The fluid 102 travels through the head 132 of the nozzle 130 and is directed at the site 106.

Preferably, the nozzle 130 is sealingly connected with the flexible hose assembly 100, and specifically, the flexible hose 110. As used herein, sealingly connected with refers to any coupling or connection which forms a seal between a first and second member and which prevents fluid, and preferably, compressed fluid from leaking. In one embodiment, the nozzle 130 is a blow-off nozzle, such as a model 1200 or 1200SS nozzle or a nozzle portion of the model 1200 or 1200SS nozzle, manufactured by ITW Vortec of Cincinnati, Ohio and which is shown in U.S. Pat. No. 4,195,780. Preferably, nozzle 130 includes an outer collar 156 which fixes or sets the flow of fluid 102 through the nozzle 130 along with the thrust provided by the flow of fluid 102 through the nozzle.

The stiffening wire 150 is located in the inner fluid channel 112 and provides the flexible hose 110 with a “memory” which allows the flexible hose 110 to be manually flexed into one of multiple fixed positions. The memory allows for fluid from the nozzle 130 at the second end 122 of the flexible hose 110 to be directed or aimed at a one of a number of predetermined locations or sites 106. If fluid 102 from the nozzle 130 is to be directed at a different site 106, the flexible hose 110 can be manually bent or re-positioned into a new set position, and the flexible hose 110 will maintain the new set position, even if the flexible hose 110, and the nozzle 130, are operating under high internal pressures. Preferably, the stiffening wire 150 is comprised of a flexible metal, such as copper, silver, gold, lead, and aluminum. In one embodiment the stiffening wire 150 is a heavy gauge copper wire from 16 guage to 2 gauge. Preferably, the stiffening wire 150 has a diameter d₁ that is from ⅓ to ½ an inside diameter d₂ of the connecting member 160 or an inside diameter d₃ of the hose 110. This allows for adequate space for fluid 102 to flow through the flexible hose assembly 100.

The connecting member 160 forms an outlet channel 164 located at the inlet 116 of the hose 110 and which extends into the inner fluid channel 112 at the inlet 116 of the flexible hose 110. Preferably, the outlet channel 164 is surrounded by at least one hose barb 168, and preferably, a plurality of hose barbs 168 which project outwardly from the outlet channel 164. Hose barbs 168 project into and press against the inner surface 114 of the flexible hose 110 to help secure the connecting member 160 to the flexible hose 110 at the first end 118 and inlet 116. The outlet channel 164 is located within the inner fluid channel 112 and surrounded by the flexible hose 110.

Preferably, a connecting end 152 of the stiffening wire 150 is fitted between the outlet channel 164 and the flexible hose 110. By fitting the connecting end 152 of the stiffening wire 150 between the outlet channel 164 and the flexible hose 110, the stiffening wire 150 may be secured to the flexible hose assembly 100. This improved method for attaching the stiffening wire 150 to the flexible hose assembly 110 reduces problems associated with the costs manufacturing the flexible hose assembly 110 and also reduces problems associated with reliability of the connection of the stiffening wire 150 with one end of the flexible hose 110.

With reference to FIG. 2, preferably, the connecting member 160 includes an attachment member 162 which is connected with the outlet channel 164 and forms an inner channel 165 which is in fluid connection with a fluid providing device (not shown), allowing for the fluid 102 to flow through and into, the outlet channel 164. Preferably, the attachment member 162 connects the connecting member 160, and the outlet channel 164 with the fluid providing device which provides fluid 102, and preferably a flow of fluid 102 or compressed fluid 102, to the flexible hose assembly 100, and specifically, to the inner channel 165, the outlet channel 164 and the inner fluid channel 112. Preferably, the fluid providing device provides a compressed fluid 102. In one embodiment, the fluid providing device is a compressor which receives fluid 102 at or near atmospheric pressure and compresses the fluid 102 to a pressure which is higher than atmospheric pressure, such as from 100 kPa to 1200 kPa, and preferably from 137 kPa to 1034 kPa.

Attachment member 162 is preferably removably connected with a complimentary attachment member of the fluid providing device. Attachment member 162 is any coupling, fitting or arrangement which can secure, and preferably, removably secure the connecting member 160 to the fluid providing device, and includes a threaded arrangement, such as a threaded member or a screw; a snap-fit arrangement; a magnetic coupling; a chemical coupling, such as glue; a thermal coupling such as a weld; and a pressure-fit coupling. In one embodiment, a gripping member 167, such as a hexagonally shaped member, is provided to help a user apply more force onto the attachment member 162, such as rotational force, in order to more tightly couple the attachment member 162 with the complimentary attachment member of the fluid providing device. Preferably, the attachment member 162 is sealingly connected with the complimentary attachment member of the fluid providing device.

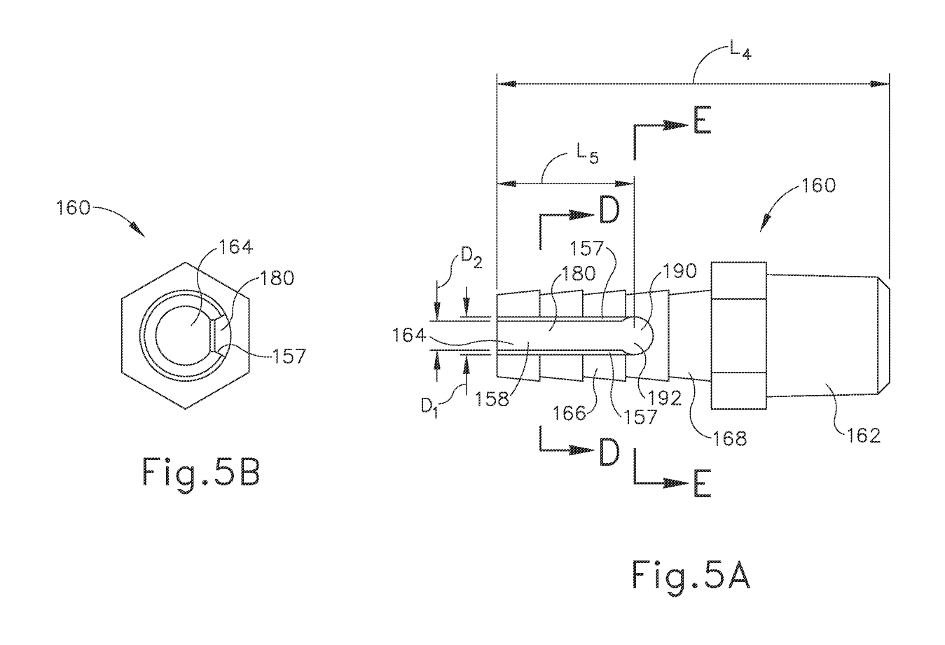

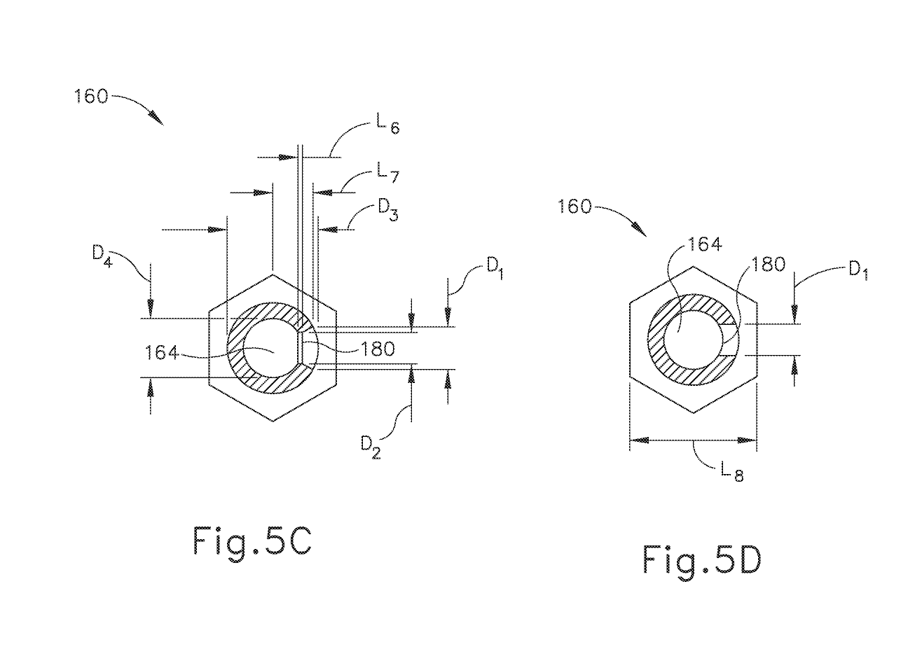

With reference to FIGS. 2, 4A, 4B, 5A, 5B, 5C, and 5D, in one embodiment, a receiving channel 180 is formed in an outer surface 166 of the connecting member 160, and preferably, the outlet channel 164. The receiving channel 180 is formed in the outer surface 166, preferably, in a direction dᵣ which is generally parallel to, ±20°, the direction d_{f} of the flow of fluid 102 through the connecting member 160, as shown in FIG. 2. Preferably, the connecting end 152 of the stiffening wire 150 is received by and at least partially located within the receiving channel 180. With reference to FIG. 5A, in one embodiment, the receiving channel 180 forms an opening 158 through the outer surface 166 of the outlet channel 164 and to the outlet channel 164. Preferably, a width of the receiving channel 180 is less than a diameter of the stiffening wire 150, so as to hold the stiffening wire 150 firmly in place.

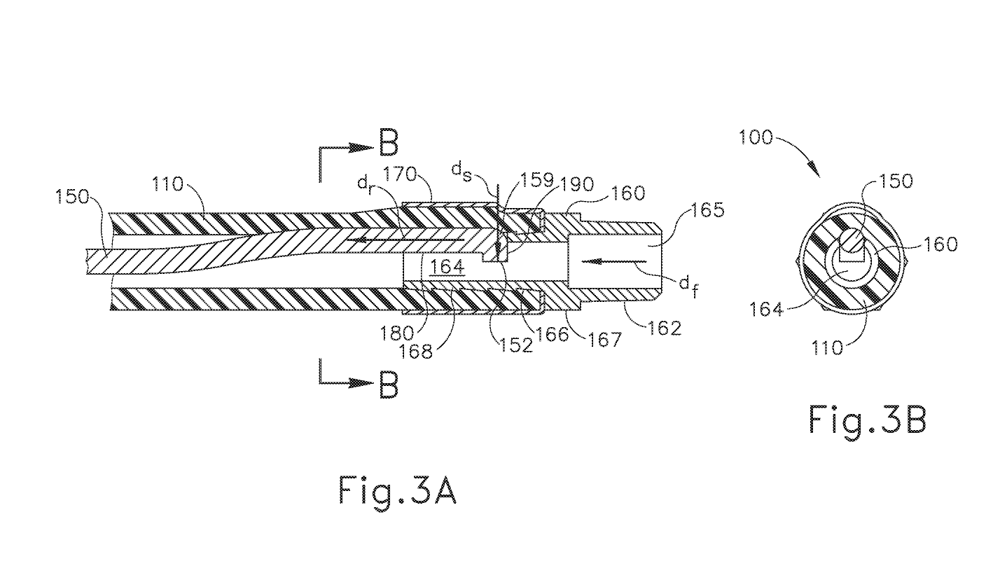

With reference to FIGS. 3A, 3B, 4A, 4B, 5A, 5B, 5C, and 5D, in one embodiment, a securing channel 190 is formed in the outer surface 166 of the connecting member 160, and preferably, the outlet channel 164, in a direction dₛ which is generally perpendicular to, ±20°, the direction d_{f} of the flow of fluid 102 through the outlet channel 164 or the direction of the outlet channel 164 which is generally the same as, ±20°, the direction d_{f} of the flow of fluid 102 through the outlet channel 164. Preferably, a bend 159 is formed near the connecting end 152 of the stiffening wire 150, and the connecting end 152 is received by and at least partially located within and secured by the securing channel 190. By forming the bend 159, and securing the connecting end 152 within the securing channel 190, the stiffening wire 150 is more securely connected with the flexible hose assembly 100.

Preferably, the receiving channel 180 and/or the securing channel 190 are formed or machined using a ball-nosed end mill. The receiving channel 180 and/or the securing channel 190 are formed as slots, portions of which go through the outer surface 166 forming an opening 158 having edges 157 which are curved or angled inwards from the outer surface 166 and towards the outlet channel 164, in order to cradle the stiffening wire 150 within the receiving channel 180. Preferably, the securing channel forms an opening 192 which is sized to receive the stiffening wire, such as a circular opening having a diameter which is slightly greater than the diameter d₁ of the stiffening wire 50.

In one embodiment, to further secure the stiffening wire 150 with the flexible hose assembly 100, the flexible hose assembly 100 further comprises a connecting end ferrule 170 at or near the first end 118 of the flexible hose 110. Preferably, the connecting end ferrule 170 surrounds the flexible hose 110, the stiffening wire 150, and the connecting member 160. Preferably, the connecting end ferrule 170 is compressed around and surrounds the flexible hose 110, the stiffening wire 150, and the connecting member 160, in order to securely and/or sealingly connect the stiffening wire 150 with the flexible hose assembly 100.

In one embodiment, to further secure the nozzle 130 with the flexible hose assembly 100, the flexible hose assembly 100 further comprises a nozzle end ferrule 138 at or near the second end 122 of the flexible hose 110. Preferably, the nozzle end ferrule 138 surrounds the flexible hose 110 and at least a portion of the nozzle 130, such as the inlet channel 134 of the nozzle 130 located within the flexible hose 110. Preferably, the nozzle end ferrule 138 is compressed around and surrounds the flexible hose 110 and at least a portion of the nozzle 130, in order to securely and/or sealingly connect the nozzle 130 with the flexible hose assembly 100.

With reference to FIG. 2, in one embodiment, a nozzle end 154 of the stiffening wire 150, which is opposed to the connecting end 152 of the stiffening wire 150, is located within the inlet channel 134 of the nozzle 130 or connected with the nozzle 130.

In assembling the flexible hose assembly 100, preferably, the stiffening wire 150, is located or placed in the inner fluid channel 112 of the flexible hose 110, and positioned in between the connecting member 160 and the flexible hose 110. Upon positioning the stiffening wire 150 between the connecting member 160 and the flexible hose 110, the stiffening wire 150 is connected with the connecting member 160. Preferably, the stiffening wire 150 is connected with the connecting member 160 by forming receiving channel 180, and/or securing channel 190, in the connecting member 160 and positioning the stiffening wire 150 in the receiving channel 180 and/or the securing channel 190. In one embodiment, upon positioning the stiffening member 150 between the connecting member 160 and the flexible hose 110, a connecting end ferrule 170 is positioned around a portion of the flexible hose 110, the connecting end 152 of the stiffening wire 150, and a portion of the connecting member 160. Preferably, the connecting end ferrule 170 is then compressed around the portion of the flexible hose 110, the connecting end 152 of the stiffening wire 150, and the portion of the connecting member 160 in order to secure the stiffening wire 150 to the flexible hose assembly 100.

At the second end 122 of flexible hose 110, nozzle 130 is connected, preferably sealingly connected, with the outlet 120 of the flexible hose 110. Upon assembly of the flexible hose assembly 100, fluid 102 is flowed through the flexible hose 110, out the nozzle 130, and directed at site 106.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. A flexible hose assembly for directing a compressed fluid towards a site comprising:
a flexible hose forming an inner fluid channel and having an inlet at a first end which receives the compressed fluid and an outlet at a second end which delivers the compressed fluid;
a nozzle connected with an outlet of the flexible hose, wherein the compressed fluid travels through the nozzle and is directed at the site;
a stiffening wire located in the inner fluid channel;
a connecting member having an outlet channel located at the inlet and in the inner fluid channel, wherein the outlet channel is surrounded by the flexible hose, and wherein a connecting end of the stiffening wire is fitted between the outlet channel and the flexible hose.

2. The assembly of claim 1, wherein a receiving channel is formed in an outer surface of the outlet channel, and wherein the connecting end of the stiffening wire is received by and at least partially located within the receiving channel.

3. The assembly of claim 1, wherein a securing channel is formed in an outer surface of the outlet channel in a direction which is generally perpendicular to the direction of the outlet channel, and wherein the connecting end of the stiffening wire is received by and at least partially located within the securing channel.

4. The assembly of claim 2, wherein a securing channel is formed in an outer surface of the receiving channel in a direction which is generally perpendicular to the direction of the receiving channel, and wherein the connecting end of the stiffening wire is received by and at least partially located within the securing channel.

5. The assembly of claim 1 further comprising a compressed connecting end ferrule at the first end of the flexible hose surrounding the flexible hose, the stiffening wire, and the connecting member.

6. The assembly of claim 1 further comprising a compressed nozzle end ferrule at the second end of the flexible hose surrounding the flexible hose, and an inlet channel of the nozzle located within the flexible hose.

7. The assembly of claim 6, wherein a nozzle end of the stiffening wire is located within the inlet channel of the nozzle.

8. The assembly of claim 1, wherein the outlet channel includes a series of hose barbs surrounding the outlet channel for securing an inner surface of the flexible hose to the outlet channel.

9. A method for attaching a stiffening wire inside a flexible hose assembly comprising:
positioning a stiffening wire, located in an inner fluid channel of a flexible hose, in between a connecting member and the flexible hose; and
connecting the stiffening wire with the connecting member.

10. The method of claim 9, wherein the connecting of the stiffing wire comprises compressing a connecting end ferrule surrounding a portion of the flexible hose, a connecting end of the stiffening wire, and a portion of the connecting member.

11. The method of claim 9, wherein the connecting of the stiffing wire comprises forming a receiving channel in an outer surface of the connecting member, and receiving a connecting end of the stiffening wire within the receiving channel.

12. The method of claim 9, wherein the connecting of the stiffing wire comprises:
forming a securing channel in an outer surface of the connecting member in a direction which is generally perpendicular to the direction of an outlet channel of the connecting member; and
receiving the connecting end of the stiffening wire within the securing channel.

13. The method of claim 9, further comprising connecting a nozzle with an outlet of the flexible hose.

14. The method of claim 13 further comprising flowing compressed air fluid through the flexible hose, out the nozzle, and directed at a site.

15. A flexible hose assembly comprising:
a flexible hose forming an inner fluid channel;
a nozzle connected with an outlet of the flexible hose;
a connecting member connected with an inlet of the flexible hose and having a portion located in the inner fluid channel; and
a stiffening wire located in the inner fluid channel between the connecting member and the flexible hose.

16. The assembly of claim 15, wherein a receiving channel is formed in an outer surface of the portion of the connecting member located in the inner fluid channel, and wherein a connecting end of the stiffening wire is received by and at least partially located within the receiving channel.

17. The assembly of claim 15, wherein the connecting member is a hose barb fitting having barbs formed around the portion of the connecting member located in the inner fluid channel.

18. The assembly of claim 15 further comprising a compressed connecting end ferrule surrounding the flexible hose, an end of the stiffening wire, and a portion of the connecting member.

19. The assembly of claim 15 further comprising a compressed nozzle end ferrule surrounding the flexible hose and an inlet channel of the nozzle located within the flexible hose.

20. The assembly of claim 15, wherein a nozzle end of the stiffening wire is located within an inlet channel of the nozzle.
